(19) United States
(12) Patent Application Publication
(10) Pub. No.: US 2007/0068106 A1
(43) Pub. Date: Mar. 29, 2007

(54) STORM SURGE SHUTTERS

(76) Inventor: Anthony J. Mangano, Callao, VA (US)

Correspondence Address: BELL, BOYD, & LLOYD LLP, P.O. BOX 1135, CHICAGO, IL, 60690, US

(21) Appl. No.: 11/530,558

(22) Filed: Sep. 11, 2006

Related U.S. Application Data
(60) Provisional application No. 60/596,472, filed on Sep. 26, 2005.

(51) Int. Cl. E06B 7/08

(52) U.S. Cl. 52/473

(57) ABSTRACT

A shutter is provided which can include a first panel having a first ornamental side and a first substantially flat side opposite the first ornamental side, a second panel having a second ornamental side and a second substantially flat side opposite the second ornamental side and a frame. The frame encloses the first panel and second panel. A portion of the first panel extends into a groove of the frame and a portion of the second panel extends into the groove of the frame. The shutter can also include a backer. The frame encloses the backer and a portion of the backer extends into the groove of the frame. A shutter system which includes a shutter is also provided. The shutter covers at least a portion of a structural opening in a closed position and exposes that portion of the structural opening in an open position. The shutter system also includes an actuator coupled to the shutter which is operable to move the shutter to the open position or the closed position. The shutter system also includes a controller configured to control the operation of the actuator in response to a signal received by the controller. The signal can be one of the group consisting of an emergency broadcast signal, an evacuation signal, a hurricane signal, a tornado signal, a tsunami signal, a riot signal, a civil unrest signal, an all clear signal, and an intrusion attempt signal.

### RELATED APPLICATIONS

This non-provisional patent application claims priority to and the benefit of U.S. Provisional Patent Application Ser. No. 60/596,472, filed Sep. 26, 2005, the entire contents of which are incorporated herein.

### BACKGROUND

High winds can cause damage to homes, businesses and other structures by damaging or destroying windows, doors or other structural openings by the forces generated by the wind or by driving debris and/or a storm surge of water into or through the windows, doors or other structural openings. Further, once the structural openings are damaged, high wind can drive additional debris or water into a structure, causing additional damage. High winds or wind-driven water entering through a damaged structural opening can even cause the structure to lose a structural portion such as a roof or a wall.

### SUMMARY

In one embodiment, a shutter is provided. The shutter includes a first panel having a first ornamental side and a first substantially flat side opposite the first ornamental side, a second panel having a second ornamental side and a second substantially flat side opposite the second ornamental side and a frame. The frame encloses the first panel and second panel. A first portion of the first panel extends into a groove of the frame and a second portion of the second panel extends into the groove of the frame.

In one embodiment, the shutter also includes a backer. The frame encloses the backer and a portion of the backer extends into the groove of the frame. In one embodiment, the backer includes a material selected from the group consisting of aluminum, steel, metal, alloy, plastic, plywood and wood. In one embodiment, the backer is at least one-eighth of an inch thick. In another embodiment, the backer is at least one-quarter of an inch thick. In one embodiment, the frame includes a material selected from the group consisting of aluminum, steel, metal, alloy, plastic and wood.

In one embodiment, the first panel and the second panel abut each other. In another embodiment, the first panel interlocks with the second panel. In a further embodiment, the first ornamental side has an appearance selected from the group consisting of louvers, raised paneling and lattice work.

In one embodiment, the shutter also includes a hinge. The hinge is configured to hingedly connect the shutter to a structure. In an open position the first ornamental side is visible from outside the structure. In a closed position the ornamental side faces at least a portion of a structural opening.

In another embodiment, a shutter system is provided. The shutter system includes a shutter. The shutter covers at least a portion of a structural opening in a closed position and exposes that portion of the structural opening in an open position. The shutter system also includes an actuator coupled to the shutter. The actuator is operable to move the shutter to the open position or the closed position. The shutter system also includes a controller configured to control the operation of the actuator. It should be appreciated that the actuator and controller are not required in various other embodiments. In one embodiment, the controller is further configured to control the operation of the actuator in response to a signal received by the controller. In a further embodiment, the signal is one of the group consisting of an emergency broadcast signal, an evacuation signal, a hurricane signal, a tornado signal, a tsunami signal, a riot signal, a looting signal, a civil unrest signal, an all clear signal, and an intrusion attempt signal. In one embodiment, the signal is transmitted to the controller at least partly by wireless transmission. In another embodiment, the signal is transmitted to the controller at least partly via the Internet. In still another embodiment, the signal is transmitted to the controller at least partly via a local network. In yet another embodiment, the signal is transmitted to the controller at least partly by a radio transmission.

In one embodiment, the structural opening is one of a group consisting of a window, a door, a vent, a dryer vent, a bathroom vent, an attic vent, a soffit vent and a chimney.

Additional features and advantages are described herein, and will be apparent from, the following Detailed Description and the figures.

### BRIEF DESCRIPTION OF THE FIGURES

FIG. 1 is a left side sectional view of a shutter in accordance with one embodiment.

FIG. 2 is a front perspective view of a shutter with a portion of one or more panels cut out to show a backer in accordance with one embodiment.

FIG. 3A is a back view of a shutter in accordance with one embodiment.

FIG. 3B is a top sectional view of a left portion of a shutter in accordance with one embodiment.

FIG. 4 is a flow diagram of the process of controlling a shutter system in accordance with one embodiment.

### DETAILED DESCRIPTION

In one embodiment, a storm surge shutter system is provided. The system protects one or more structural openings from damage caused by wind, debris, water and/or other damaging items during periods of high winds or other potentially damaging conditions. Preferably, the system includes one or more shutters which can be positioned in at least an open or closed position. In an closed position, a shutter preferably covers a portion of structural opening; however, a shutter can cover an entire structural opening or some or all of more than one structural openings or any other suitable arrangement, or can be positioned to protect a portion of or the entirety of one or more structural openings in any other suitable manner.

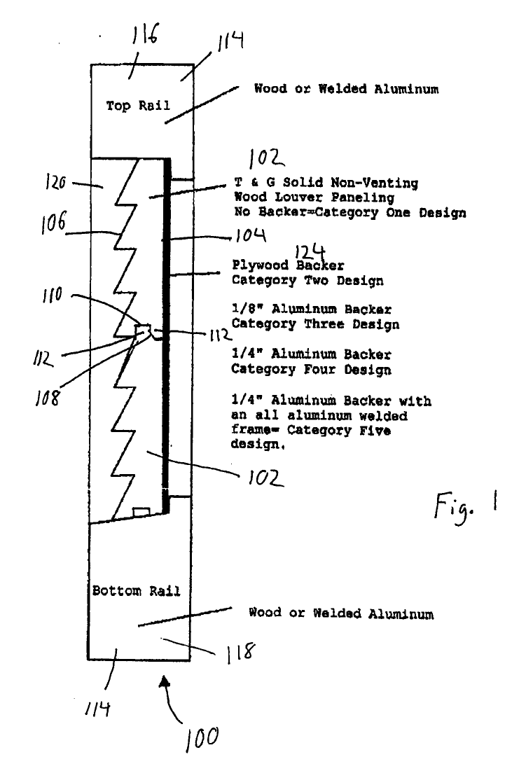

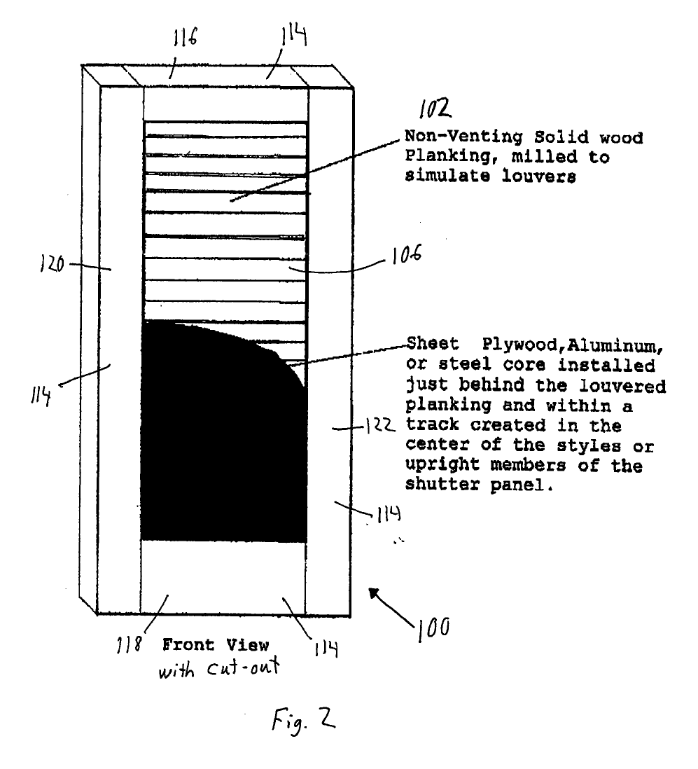

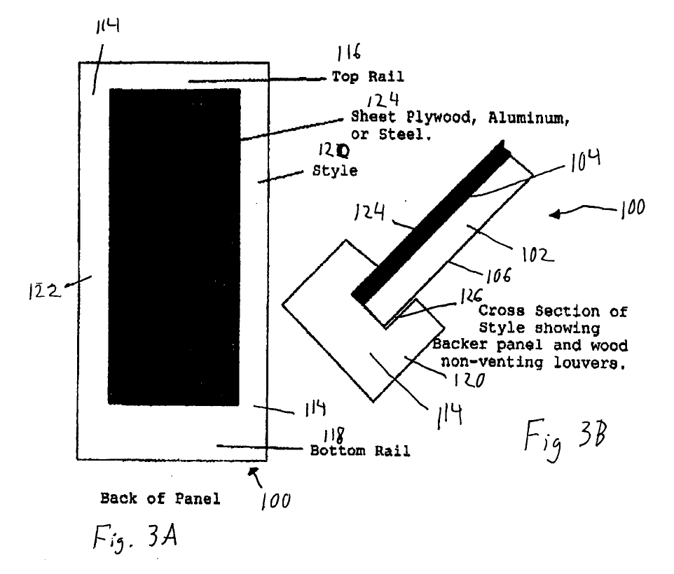

A shutter in accordance with one embodiment is shown in FIGS. 1-3A and 3B. Preferably, a shutter 100 includes a plurality of panels 102; however, a shutter can include a single panel or no panels. The panels 102 are preferably wooden; however, the panels 102 can be metal, plastic or any other suitable material or combination of materials. Further, one side 104 of the panels 102 is preferably substantially flat; however, the side 104 can have any suitable shape. Another side 106 opposite side 104 is preferably ornamental; however, side 106 is not required to be ornamental. For example, side 106 can have a jagged edge, resulting in the panels 102 appearing to have louvers; however, the panels 102 can have any other suitable ornamental design or designs on side 106 to produce any suitable combined or individual appearance, including but not limited to the appearance of raise paneling or lattice work.

Preferably the panels 102 are arranged substantially planarly such that there are no gaps between panels 102; however, the panels 102 can be arranged in any suitable manner. Further, the panels 102 are preferably arranged such that the top of one panel 108 abuts the bottom of another panel 110; however, the panels can be arranged in any suitable configuration. Panels 102 can have substantially identical structure; however panels 102 can alternatively have varying structure, such as different lengths, widths, thicknesses or connector arrangements or any other suitable structural variations. Preferably, panels 102 are fitted together by interlocking connectors 112; however, panels 102 can have sides which abut other panels 102 without interlocking.

Preferably, the panels 102 are enclosed by a frame 114; however, it is not required to enclose the panels 102. Preferably, the frame 114 includes a top rail 116, a bottom rail 118, a left rail or style 120 and a right rail or style 122; however, the frame can have any suitable number or rails or styles and can be any suitable shape, including but not limited to circular, semi-circular, oval, triangular or free-form. Preferably, the frame 114 is wooden; however, the frame 114 can include aluminum, steel, other metal, plastic or any other suitable substance or substances. Preferably, rails or sections of the frame are joined together with interlocking connectors; however, the rails or sections can be joined together by adhesive, a weld, epoxy or any other suitable joining mechanism or combination of mechanisms.

Preferably, a backer 124 abuts the substantially flat side 104 of the panels 102; however, a backer 124 is not required. The backer 124 is preferably aluminum; however, the backer 124 can be plywood, steel, plastic, any sheet metal or any other suitable substance or substances.

Preferably, a portion of the panels 102 and backer 124 are disposed within a groove 126 of one or more of the rails of the frame 114; however, the panels 102 and/or backer 124 can be attached to the frame 114 in any suitable manner. The groove 126 is preferably rectangular; however, the groove 126 can be any suitable shape, including but not limited to shapes which would require the panels 102 and backer 124 to be slid into place by sliding a top or bottom edge of the portion that extends into the groove and the bottom or top of the groove and sliding the portion along the entire length of the groove. Further, in various embodiments, a rail can have more than one groove.

Preferably, two shutters are placed on opposite sides of a structural opening; however, any suitable number of shutters, including but not limited to one or three or more, can be placed by a structural opening in any suitable location. Preferably, a shutter is hingedly attached to the structure; however, the shutter can be slideably attached or attached in any other suitable manner. In the open position, the shutters allow access to the structural opening from the outside of the structure. Further, preferably, the ornamental side 106 of the panels 102 is visible from the outside of the structure when the shutters are in the open position; however, the shutters can be arranged in any suitable manner. Preferably, when the two shutters are in the closed position, the shutters cover the structural opening, with the backer 124, if any, or substantially smooth side being visible from outside the structure; however, the shutters can be in any suitable configuration in a closed position. Preferably, the shutters abut each other in the closed position and completely close off or seal off the structural opening from exposure to the outside of the structure; however, the shutters can overlap, interlock, or have any other suitable configuration. The shutters are preferably sized and shaped in accordance with the structural opening with which they are associated; however, the shutters can be sized and shaped in standard sizes and shapes or in any other suitable manner. Further, preferably, the shutters can be manually or automatically locked or latched together in the closed position; however, the shutters are not required to be capable of being locked or latched together.

Because the panels 102 individually and collectively preferably do not permit substantial amounts or any amounts of air to pass though (i.e., they are non-venting), the structural openings are protected against the force of the wind when the shutters are closed. Further, the interlocking configuration of the panels 102 of various embodiments increases the ability of the shutters to withstand flying debris. This ability is also increased in various embodiments in which portions of the panels 102 extend into a groove in at least part of the frame 114 enclosing the panels 102. Further, the backer 124, if present, also preferably does not permit substantial amounts or any amounts of air to pass through. As a result, embodiments with a backer 124 increase the protection provided by the shutter against the force of the wind. Further, the backer 124 provides extra protection against flying debris, and various embodiments include backers 124 of varying thicknesses and strengths, including but not limited to one-eight of an inch, one quarter of an inch, one half of an inch or any other suitable thickness. As a result, various embodiments provide various degrees of protection against wind force, flying debris (including small particle debris such as sand and large particle debris such as boards, poles and bricks), surging water, driven rain or hail, and other hazards to structural openings during high wind and/or storm conditions.

Preferably a shutter system includes sufficient shutters to protect each structural opening, such as windows, doors, vents (including but not limited to dryer vents, bathroom vents, attic vents and soffit vents), chimneys or any other suitable opening to a structure; however, the shutter system is not required to protect each structural opening.

In one embodiment, shutters are manually moved between open and closed positions. In another embodiment, shutters are automatically moved between open and closed positions. Preferably, an actuator is attached to each shutter; however, an actuator is not required. The actuator can move the shutter between open and closed in any suitable manner. A control system controls the actuator, and preferably both the control system and the actuator are powered by the structure's electrical system with a battery backup; however, the actuator and controller can be powered in any suitable manner.

Preferably, the controller can receive a signal transmitted via a wire or wirelessly from another device; however, the controller is not required to receive a signal from another device. The controller can control the actuator and thereby the position of the shutter in accordance with the received signal. For example, in one embodiment, the controller can cause the shutter to move to the closed position if it receives (via radio, cellular transmission, Internet signal or any other suitable communications carrier) an emergency broadcast signal or similar indicating that severe weather, a tidal wave, storm surge, a riot, civil unrest (e.g., due to a controversial court decision, a local sports team victory or defeat, or any other possible cause of civil unrest) or any other potentially destructive condition exists or may soon exist. As a result, the structure's openings are protected even if an occupant is not present to close the shutters manually or by providing a local close signal to the controller. Preferably, the controller can also automatically open the shutters upon receipt of an all-clear or similar signal.

In another embodiment, a user can remotely control the shutters of a structure by sending a signal to the controller via the Internet, cellular phone, or any other suitable communications carrier. As a result, the user can close the shutters even if the user is distantly located and learns of a storm, riot or other potentially destructive situation at the structure's location. In various other embodiments, a user can control a shutter by an input device (e.g., a button, switch or any other suitable device) associated with the shutter, by a local wired or wireless network, or by any other suitable signal transmitting system.

In another embodiment, the shutters of the system are individually controllable. Preferably, the user can program the shutters, individually or in groups of two or more, to open and close randomly or according to a schedule; however the capability of programming the shutters is not required. Through such a program, a user can control the amount and type of light that enters a structure, or a user can provide the appearance of someone being present in the structure regardless of whether someone is actually present. In one embodiment, the program adjusts the shutter schedule in accordance with sunrise and sunset schedules to compensate for the variation of those events' timing during the year. Preferably, a program is overridden by an emergency signal; however, such an override is not required. Similarly, preferably a signal input from a user overrides an emergency signal; however, such an override is not required.

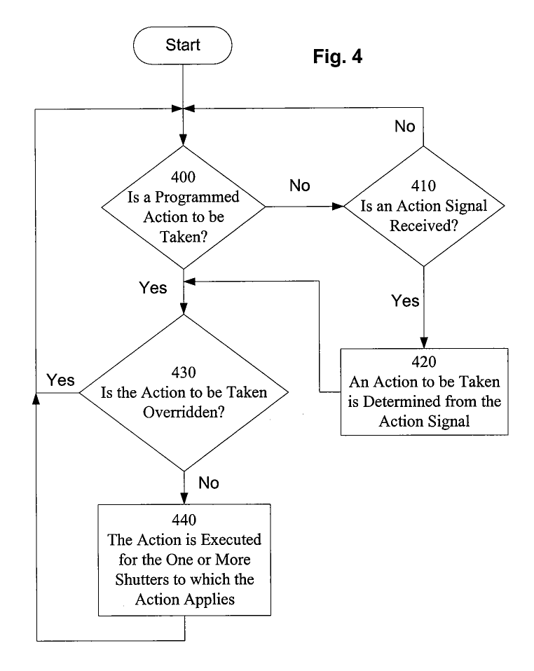

FIG. 4 shows the process of controlling one or more shutters in accordance with one embodiment of the present invention. At step 400, it is determined whether a programmed action is to be taken. The programmed action to be taken can be pending as a result of a regularly programmed schedule or as the result of a randomly or pseudorandomly generated event. If a programmed action is to be taken, the process proceeds at step 430. If there is not a programmed action to be taken, at step 410, it is determined whether an action signal is received. An action signal can be an emergency broadcast signal, an input sent to the controller from a remote or local user via any suitable transmission mechanism, a signal from home alarm system indicating a intrusion attempt or any other suitable type of signal. If an action signal is not received, the process repeats at step 400. If an action signal is received, at step 420, an action to be taken is determined from the action signal.

At step 430, it is determined whether the action to be taken is overridden. An action can be overridden by another action, a setting, or any other suitable override condition. If the action is overridden, the action is not executed and the process repeats at step 400. If the action is not overridden, at step 440, the action is executed for the one or more shutters to which the action applies and the process repeats at step 400. An action can apply to a single shutter, a group of shutters or all shutters in the system. Further, an action can have different effects on different shutters. For example, a single action can cause the shutters on the windows on one side of the house to close and the shutters on another side of the house to open.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A shutter comprising:
a first panel having a first ornamental side and a first substantially flat side opposite the first ornamental side;
a second panel having a second ornamental side and a second substantially flat side opposite the second ornamental side; and
a frame, wherein the frame encloses the first panel and second panel, a first portion of the first panel extending into a groove of the frame and a second portion of the second panel extending into the groove of the frame.

2. The shutter of claim 1, further comprising:
a backer, wherein the frame encloses the backer, a portion of the backer extending into the groove of the frame.

3. The shutter of claim 2, wherein the backer includes a material selected from the group consisting of aluminum, steel, metal, alloy, plastic, plywood and wood.

4. The shutter of claim 2, wherein the backer is at least one-eighth of an inch thick.

5. The shutter of claim 2, wherein the backer is at least one-quarter of an inch thick.

6. The shutter of claim 1, wherein the frame includes a material selected from the group consisting of aluminum, steel, metal, alloy, plastic and wood.

7. The shutter of claim 1, wherein the first panel and the second panel abut each other.

8. The shutter of claim 1, wherein the first panel interlocks with the second panel.

9. The shutter of claim 1, wherein the first ornamental side has an appearance selected from the group consisting of louvers, raised paneling and lattice work.

10. The shutter of claim 1, further comprising:
a hinge, configured to hingedly connect the shutter to a structure, wherein in an open position the first ornamental side is visible from outside the structure and in a closed position the ornamental side faces at least a portion of a structural opening.

11. A shutter system comprising:
a shutter, wherein the shutter covers at least a portion of a structural opening in a closed position and exposes the at least portion of the structural opening in an open position;
an actuator coupled to the shutter, the actuator operable to move the shutter to the open position or the closed position; and
a controller configured to control the operation of the actuator.

12. The shutter system of claim 11, wherein the controller is further configured to control the operation of the actuator in response to a signal received by the controller.

13. The shutter system of claim 12, wherein the signal is one of the group consisting of an emergency broadcast signal, an evacuation signal, a hurricane signal, a tornado signal, a tsunami signal, a riot signal, a looting signal, a civil unrest signal, an all clear signal, and an intrusion attempt signal.

14. The shutter system of claim 12, wherein the signal is transmitted to the controller at least partly by wireless transmission.

15. The shutter system of claim 12, wherein the signal is transmitted to the controller at least partly via the Internet.

16. The shutter system of claim 12, wherein the signal is transmitted to the controller at least partly via a local network.

17. The shutter system of claim 12, wherein the signal is transmitted to the controller at least partly by a radio transmission.

18. The shutter system of claim 11, wherein the structural opening is one of a group consisting of a window, a door, a vent, a dryer vent, a bathroom vent, an attic vent, a soffit vent and a chimney.

19. The shutter system of claim 11, wherein the shutter includes:
a first panel having a first ornamental side and a first substantially flat side opposite the first ornamental side;
a second panel having a second ornamental side and a second substantially flat side opposite the second ornamental side; and
a frame, wherein the frame encloses the first panel and second panel, a first portion of the first panel extending into a groove of the frame and a second portion of the second panel extending into the groove of the frame.

20. The shutter system of claim 19, wherein the shutter includes a backer, wherein the frame encloses the backer, a portion of the backer extending into the groove of the frame.
